(19) United States
(12) Patent Application Publication
(10) Pub. No.: US 2025/0296334 A1
(43) Pub. Date: Sep. 25, 2025

(54) LIQUID DISCHARGE HEAD, LIQUID DISCHARGE UNIT, AND LIQUID DISCHARGE APPARATUS

(71) Applicants: Yuhei KANESAKA, Kanagawa (JP); Takahiro YOSHIDA, Kanagawa (JP)

(72) Inventors: Yuhei KANESAKA, Kanagawa (JP); Takahiro YOSHIDA, Kanagawa (JP)

(21) Appl. No.: 19/083,484

(22) Filed: Mar. 19, 2025

(30) Foreign Application Priority Data
Mar. 22, 2024 (JP) 2024-046896

(51) Int. Cl. B41J 2/14; B41J 3/54

(52) U.S. Cl. CPC B41J 2/1433; B41J 3/543

(57) ABSTRACT

A liquid discharge head includes a nozzle plate. The nozzle plate has multiple nozzle arrays each having multiple nozzles arrayed in an array direction. The multiple nozzles discharge a liquid onto a recording medium being conveyed in a conveyance direction orthogonal to the array direction. The multiple nozzle arrays include a first nozzle array and a second nozzle array. The first nozzle array has a first distance between both end nozzles of the multiple nozzles at both ends of the first nozzle array in the array direction. The second nozzle array is disposed upstream from the first nozzle array in the conveyance direction. The second nozzle array has a second distance between both end nozzles of the multiple nozzles at both ends of the second nozzle array in the array direction, and the second distance is shorter than the first distance.

### CROSS-REFERENCE TO RELATED APPLICATION

This patent application is based on and claims priority pursuant to 35 U.S.C. § 119(a) to Japanese Patent Application No. 2024-046896, filed on Mar. 22, 2024, in the Japan Patent Office, the entire disclosure of which is hereby incorporated by reference herein.

### BACKGROUND

### Technical Field

The present disclosure relates to a liquid discharge head, a liquid discharge unit, and a liquid discharge apparatus.

### Related Art

In a liquid discharge head, liquid is discharged from nozzles, and the liquid (liquid droplets) lands on a medium to form dots.

### SUMMARY

The present disclosure described herein provides an improved liquid discharge head including a nozzle plate. The nozzle plate has multiple nozzle arrays each having multiple nozzles arrayed in an array direction. The multiple nozzles discharge a liquid onto a recording medium being conveyed in a conveyance direction orthogonal to the array direction. The multiple nozzle arrays include a first nozzle array and a second nozzle array. The first nozzle array has a first distance between both end nozzles of the multiple nozzles at both ends of the first nozzle array in the array direction. The second nozzle array is disposed upstream from the first nozzle array in the conveyance direction. The second nozzle array has a second distance between both end nozzles of the multiple nozzles at both ends of the second nozzle array in the array direction, and the second distance is shorter than the first distance.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIGS. 1A and 1B are schematic plan views of a nozzle plate according to a comparative example;

FIGS. 2A and 2B are schematic plan views of a nozzle plate according to a first example;

FIG. 3 is another schematic plan view of the nozzle plate of FIGS. 2A and 2B, according to the first example;

FIGS. 4A and 4B are schematic plan views of a nozzle plate according to a second example;

FIGS. 5A and 5B are schematic plan views of a nozzle plate according to a third example;

FIGS. 6A and 6B are schematic plan views a nozzle plate according to a comparative example, illustrating a stream of an airflow;

FIG. 7 is a schematic plan view of a liquid discharge apparatus;

FIG. 8 is a schematic side view of the liquid discharge apparatus of FIG. 7;

FIG. 9 is a schematic view of a liquid discharge unit;

FIG. 10 is another schematic view of a liquid discharge unit;

FIG. 11 is an exploded perspective view of a head module;

FIG. 12 is a further exploded perspective view of the head module of FIG. 11;

FIG. 13 is an exploded perspective view of the head module of FIG. 11 as viewed from a nozzle face side thereof;

FIG. 14 is a cross-sectional view of one head of the head module of FIG. 11 in a transverse direction of the head;

FIG. 15 is a schematic view of another liquid discharge apparatus.

FIG. 16 is a plan view of a head unit of the liquid discharge apparatus of FIG. 15;

FIG. 17 is a plan view of another head unit; and

FIG. 18 is a schematic view of another liquid discharge apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

In a liquid discharge head, liquid is discharged from nozzles, and the liquid (liquid droplets) lands on a medium to form dots. The liquid discharged from the nozzles may land at a landing position deviating from a target position due to influence of an airflow. The landing position of the liquid is prevented from deviating from the target position, for example, as follows.

In a comparative example, an arrangement interval of discharge ports in an end region of a discharge port array located on the most upstream side in a relative movement direction with respect to a recording medium is narrower than an arrangement interval of discharge ports in an end region of a discharge port array located on the most downstream side in the relative movement direction. The discharge ports may be referred to as nozzles, and a discharge port array may be referred to as a nozzle array in the following description. In the comparative example, rectangular recording element substrates are arranged in a staggered manner. The recording element substrate may be referred to as a nozzle plate in the following description.

Accordingly, the deviation of the landing position of the liquid droplets due to an inflow airflow can be reduced. The inflow airflow is generated when a liquid discharge head in which recording element substrates are arranged in a staggered manner is used. As a result, a high-quality image can be printed at high speed.

In such a liquid discharge head, a conveyance airflow due to the conveyance of the recording medium and a self-airflow due to the discharged liquid droplets are generated, which may cause the discharged liquid droplets to deflect (i.e., discharge deflection). The discharge deflection due to the airflow at the end of the recording element substrate is determined by the conveyance airflow due to the conveyance of the recording medium and the self-airflow due to the discharged liquid droplets.

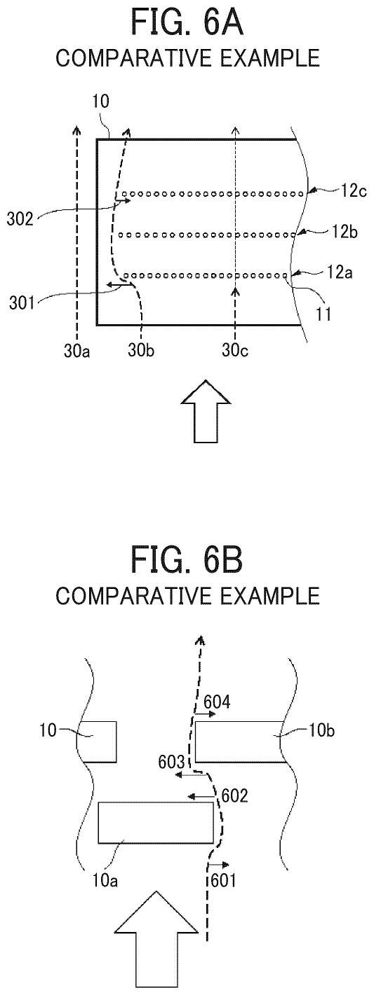

In FIG. 6A, the recording element substrate (i.e., a nozzle plate 10) has multiple nozzle arrays 12a, 12b, and 12c each having nozzles 11 arrayed in an array direction. When a recording medium is conveyed in a conveyance direction indicated by the outlined arrow in FIG. 6A, for example, the conveyance airflow in the vicinity of the end of the recording element substrate flows on a route indicated by a dashed arrow 30b illustrated in FIG. 6A. The conveyance airflow flows straight in the other portions as indicated by dashed arrows 30a and 30c in FIG. 6A. When multiple recording element substrates (e.g. nozzle plate 10, 10a, and 10b) are arranged as illustrated in FIG. 6B, the conveyance airflow flows through a route indicated by the dashed arrow in FIG. 6B. As illustrated in FIG. 6A, the conveyance airflow flowing on the route indicated by the arrow 30b affects the liquid droplets at the end of the nozzle array 12a in the array direction on the upstream side in the conveyance direction toward the outside of the recording element substrate in the array direction as indicated by an arrow 301 in FIG. 6A. The conveyance airflow flowing on the route indicated by the arrow 30b affects the liquid droplets at the end of a nozzle array 12c in the array direction on the downstream side in the conveyance direction toward the inside of the recording element substrate in the array direction as indicated by an arrow 302 in FIG. 6A. Thus, when the recording element substrates are arranged in a staggered manner, the direction of the conveyance airflow changes at the upstream end and the downstream end of the recording element substrate as indicated by arrows 601 and 602, or arrows 603 and 604 in FIG. 6B, which may change the landing position of the liquid droplets.

To reduce the change in the landing position of the liquid droplets due to the conveyance airflow, in the comparative example, the nozzle interval at the upstream end of the recording element substrate is narrowed and the nozzle interval at the downstream end is widened. In the comparative example, such a nozzle arrangement in consideration of the influence of the self-airflow caused by the discharged liquid droplets can reduce the influence of the conveyance airflow on the liquid droplets.

However, when the influence of the conveyance airflow is reduced by changing the nozzle interval as described above, the nozzle arrangement may be changed each time depending on printing conditions (e.g. the conveyance speed of the recording medium). Further, the nozzle intervals are not equal between the nozzle array on the upstream side and the nozzle array on the downstream side in some areas of the recording element substrate. Accordingly, image quality may be adversely affected by the influence of the physical nozzle arrangement. In addition, since the nozzle intervals are not equal between the nozzle array on the upstream side and the nozzle array on the downstream side in some areas, a control method for reducing the influence of the change in the landing position (i.e., landing position deviation) of the liquid droplets is limited. For example, it is difficult to adopt control such as changing the size of the liquid droplets or designating the nozzles to discharge the liquid droplets due to the areas where the nozzle intervals are not equal.

In the present embodiment, a liquid discharge head can be provided in which it is not necessary to change the nozzle interval between the nozzle arrays at the ends of the nozzle arrays in consideration of the landing position deviation of the liquid droplets due to the conveyance airflow of the recording medium, and the degree of flexibility of the control method for reducing the influence of the landing position deviation of the liquid droplets at the ends of the nozzle arrays is prevented from being narrowed.

A liquid discharge head, a liquid discharge unit, and a liquid discharge apparatus according to embodiments of the present disclosure are described below with reference to the drawings. Embodiments of the present disclosure are not limited to the embodiments described below and may be other embodiments than the embodiments described below. The following embodiments may be modified by, for example, addition, modification, or omission within the scope that would be obvious to one skilled in the art. Any aspects having advantages as described for the following embodiments according to the present disclosure are included within the scope of the present disclosure.

A liquid discharge head according to an embodiment of the present disclosure is a liquid discharge head including a nozzle plate having two or more nozzle arrays. Nozzles are arrayed in the nozzle array to discharge a liquid onto a recording medium being conveyed. When a distance from a nozzle at one end to a nozzle at the other end in the nozzle array is defined as a nozzle array distance, in the nozzle plate, the nozzle array distance of the nozzle array disposed on the upstream side in the conveyance direction of the recording medium is shorter than the nozzle array distance of the nozzle array disposed on the downstream side in the conveyance direction of the recording medium.

A liquid discharge unit according to an embodiment of the present disclosure includes the liquid discharge head according to the present embodiment. A liquid discharge apparatus according to an embodiment of the present disclosure includes the liquid discharge head according to the present embodiment or the liquid discharge unit according to the present embodiment.

In the present embodiment, the conveyance airflow at the end portion of the nozzle plate can be gently released in one direction without a difference in the direction of the airflow between the upstream side and the downstream side. Accordingly, it is not necessary to change the nozzle interval between the nozzle arrays at the end of the nozzle array in consideration of the landing position deviation of the liquid droplets due to the conveyance airflow of the recording medium. Thus, the nozzle arrangement is not changed each time depending on the printing conditions (e.g., the conveyance speed of the recording medium), which facilitates the design of the liquid discharge head and reduces the cost of the liquid discharge head.

In the comparative example, since the nozzle intervals are not equal between the nozzle array on the upstream side and the nozzle array on the downstream side in some areas, the control method for reducing the influence of the change in the landing position of the liquid droplets is limited. For example, it is difficult to adopt control such as changing the size of the liquid droplets or designating the nozzles to discharge the liquid droplets due to the areas where the nozzle intervals are not equal.

In contrast, in the present embodiment, it is not necessary to change the nozzle interval between the nozzle arrays at the ends of the nozzle arrays, and the degree of flexibility of the control method for reducing the influence of the landing position deviation of the liquid droplets at the ends of the nozzle arrays is prevented from being narrowed. In the present embodiment, as described above, the direction of the airflow is simplified without a difference in the direction of the airflow between the upstream side and the downstream side to prevent the degree of flexibility in selecting the control method for reducing the influence of the change in the landing position of the liquid droplets from being narrowed. When the influence of the change in the landing position of the liquid droplets is reduced, for example, the droplet size may be changed or the nozzles to discharge the liquid droplets are designated by control on the system side.

In addition, in the present embodiment, since it is not necessary to change the nozzle interval at the ends of the nozzle arrays between the nozzle arrays, the influence of the physical nozzle arrangement does not adversely affect the image quality. The areas where the nozzle intervals are not equal may adversely affect the image quality.

The liquid discharge head of the present embodiment may be a line type or a serial type. In the present embodiment, the liquid is discharged onto the recording medium being conveyed, but in the present embodiment, the liquid discharge head may be moved (scanned) and discharge liquid onto the recording medium not in motion. In this case, for example, the conveyance direction of the recording medium may be a relative movement direction as appropriate.

Embodiments of the present disclosure are described below with reference to the drawings. In the following description, terms such as upstream and downstream may be used. Unless otherwise specified, the term “upstream” means the upstream side in the conveyance direction of the recording medium, and the term “downstream” means the downstream side in the conveyance direction of the recording medium. A nozzle plate will be described as an example. The recording medium may be referred to as, for example, a medium, a discharge target, or a base material.

### COMPARATIVE EXAMPLE

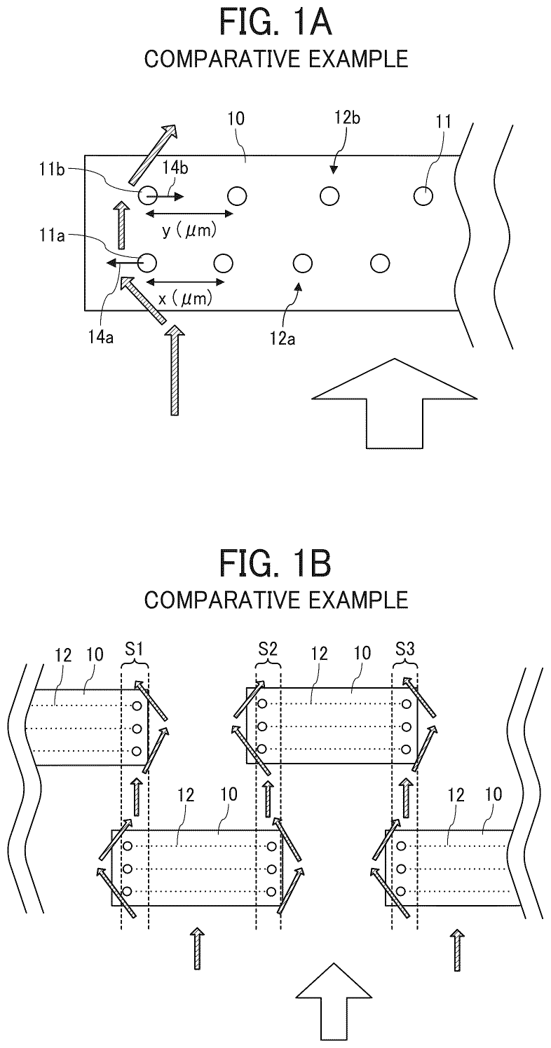

FIGS. 1A and 1B are schematic plan views of a nozzle plate according to a comparative example. A liquid discharge head of the comparative example includes a nozzle plate 10 having two or more nozzle arrays 12a and 12b each having nozzles 11 arrayed in the array direction.

FIG. 1A illustrates the two nozzle arrays 12a and 12b. In FIGS. 1A and 1B and other drawings, the outlined arrow indicates the conveyance direction of the recording medium, and hatched arrows schematically indicate the conveyance airflow.

In FIG. 1A, the nozzle array on the upstream side in the conveyance direction is referred to as the nozzle array 12a, and the nozzle array on the downstream side in the conveyance direction is referred to as the nozzle array 12b. The nozzle at the end of the nozzle array 12a is referred to as a nozzle 11a (i.e., an end nozzle), and the nozzle at the end of the nozzle array 12b is referred to as a nozzle 11b (i.e., an end nozzle). In the comparative example, as illustrated in FIG. 1A, the nozzle plate 10 has a rectangular planar shape. As illustrated in FIG. 1B, in a liquid discharge unit of the comparative example, the rectangular nozzle plates 10 are arranged in a staggered manner.

In the comparative example, the conveyance airflow due to the conveyance of the recording medium at the end portion of the nozzle plate 10 flows as indicated by the hatched arrows in FIGS. 1A and 1B. Accordingly, as illustrated in FIG. 1A, in the nozzle array 12a on the upstream side in the conveyance direction in the nozzle plate 10, the nozzle 11a at the end receives force in the outward direction of the nozzle plate 10. The outward direction is indicated by an arrow 14a pointing to the left on the surface of the paper on which FIG. 1A is drawn. On the other hand, in the nozzle array 12b on the downstream side in the conveyance direction in the nozzle plate 10, the nozzle 11b at the end receives force in the inward direction of the nozzle plate 10. The inward direction is indicated by an arrow 14b pointing to the right on the surface of the paper on which FIG. 1A is drawn.

The pressure in the vicinity of the nozzle when the liquid is discharged generates an airflow flowing toward the nozzle (i.e., self-airflow). As a result, the landing position of the liquid droplets may change (deviate) from a desired position. Since the change in the landing position of the liquid droplets affects the image quality, the change in the landing position of the liquid droplet is preferably controlled.

However, in the comparative example, a method for preventing the influence of the landing position deviation of the liquid droplets on the image quality is limited. In the comparative example, the landing positions of the liquid droplets at the ends of the nozzle arrays deviate in the directions indicated by the arrows 14a and 14b, respectively. In the comparative example, the landing positions deviate in the opposite directions between the end of the nozzle array 12a on the upstream side and the end of the nozzle array 12b on the downstream side. As illustrated in FIG. 1A, the arrow 14a and the arrow 14b point in the opposite directions. When the landing positions of the liquid droplets deviate in the opposite directions between the nozzle arrays, it is difficult to adopt control on the system side such as changing the size of the liquid droplets or designating the nozzles to discharge the liquid droplets. Accordingly, in the comparative example, the method is limited to a method of changing the nozzle interval at the end of the nozzle array 12a on the upstream side and the nozzle interval at the end of the nozzle array 12b on the downstream side.

In the comparative example, the nozzle interval at the end of the nozzle array 12a on the upstream side is narrower than the nozzle interval at the end of the nozzle array 12b on the downstream side to prevent the change in the landing position of the liquid droplets in consideration of the influence of the self-airflow. In FIG. 1A, x (μm) represents the nozzle interval at the end of the nozzle array 12a on the upstream side, y (μm) represents the nozzle interval at the end of the nozzle array 12b on the downstream side, and a relationship x<y is satisfied.

However, as in the comparative example, when the influence of the conveyance airflow is reduced by changing the nozzle interval, it is necessary to change the nozzle arrangement each time depending on the printing conditions (e.g., the conveyance speed of the recording medium). Further, since the nozzle intervals are not equal on the upstream side and the downstream side in some areas of the nozzle plate 10, the physical nozzle arrangement may adversely affect the image quality.

### First Example

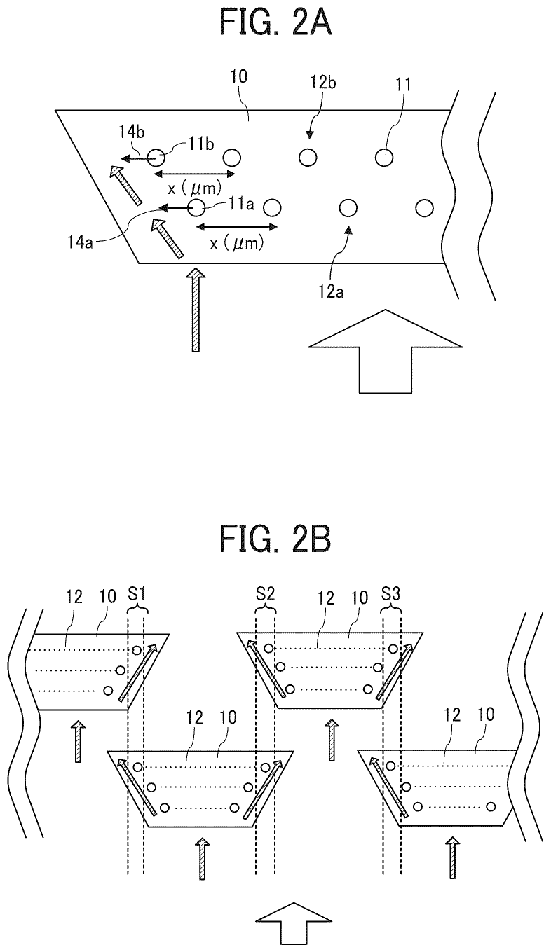

FIGS. 2A and 2B are schematic plan views of a nozzle plate according to a first example. A liquid discharge head of the first example includes a nozzle plate 10 having two or more nozzle arrays 12a and 12b each having nozzles 11 arrayed in the array direction.

Although FIG. 2A illustrates the two nozzle arrays 12a and 12b, the number of rows of the nozzle arrays may be three or more. In FIGS. 2A and 2B, the outlined arrow indicates the conveyance direction of the recording medium, and hatched arrows schematically indicate the conveyance airflow.

In FIG. 2A, the nozzle array on the upstream side in the conveyance direction is referred to as the nozzle array 12a, and the nozzle array on the downstream side in the conveyance direction is referred to as the nozzle array 12b. The nozzle at the end of the nozzle array 12a is referred to as a nozzle 11a, and the nozzle at the end of the nozzle array 12b is referred to as a nozzle 11b. In the first example, as illustrated in FIG. 2A, the nozzle plate 10 has a trapezoidal planar shape. As illustrated in FIG. 2B, in a liquid discharge unit of the first example, the trapezoidal nozzle plates 10 are arranged in a staggered manner.

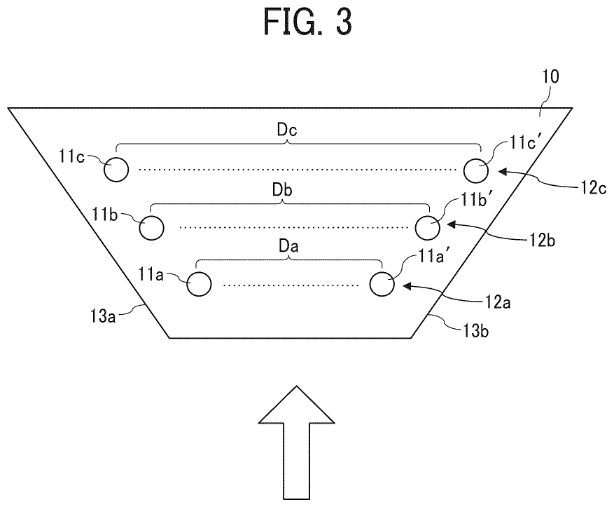

FIG. 3 is another schematic plan view of the nozzle plate according to the first example, illustrating a nozzle array distance. FIG. 3 illustrates three nozzle arrays, which are referred to as nozzle arrays 12a, 12b, and 12c from the upstream side in the conveyance direction of the recording medium. When the nozzle arrays are described without distinction, the nozzle arrays 12a, 12b, and 12c may be referred to as nozzle arrays 12, each of which may be referred to as a nozzle array 12. The nozzle at one end of the nozzle array 12a is referred to as the nozzle 11a, and the nozzle at the other end is referred to as a nozzle 11a′. The nozzle at one end of the nozzle array 12b is referred to as the nozzle 11b, and the nozzle at the other end is referred to as a nozzle 11b′. The nozzle at one end of the nozzle array 12c is referred to as a nozzle 11c, and the nozzle at the other end is referred to as a nozzle 11c′. The distance from the nozzle at one end (i.e., the end nozzle) to the nozzle at the other end (i.e., the end nozzle) in the nozzle array is referred to as a nozzle array distance. The nozzle array distance may be referred to as the distance between both ends (i.e., from one end to the other end) of the nozzle array. In FIG. 3, the nozzle array distances of the nozzle arrays 12a, 12b, and 12c are nozzle array distances Da, Db, and Dc, respectively. For example, the distance from the nozzle 11a at one end of the nozzle array 12a to the nozzle 11a′ at the other end is the nozzle array distance Da.

In the nozzle plate 10 of the first example, the nozzle array distance on the upstream side is shorter than the nozzle array distance on the downstream side in the conveyance direction. In the example illustrated in FIG. 3, the nozzle array distance Da of the nozzle array 12a is shorter than the nozzle array distance Db of the nozzle array 12b on the downstream side, and the nozzle array distance Db of the nozzle array 12b is shorter than the nozzle array distance Dc of the nozzle array 12c on the downstream side.

Due to such a configuration, the conveyance airflow can be gently released in one direction without a difference in the direction of the influence of the conveyance airflow flowing at the end portion of the nozzle plate 10 between the upstream side and the downstream side. For example, as illustrated in FIG. 2A, the arrow 14a and the arrow 14b schematically illustrating the self-airflows are directed in the same direction. Accordingly, the direction of the change in the landing position due to the conveyance airflow can be the same one direction. As illustrated in FIGS. 2A and 2B, the airflows, which are indicated by the hatched arrows, flowing from the upstream side in the conveyance direction of the recording medium toward the nozzle plate 10 flow along the ends of the nozzle arrays in one nozzle plate 10.

In the first example, the landing position is changed (deviated) in one direction by the conveyance airflow, which facilitates the correction of the change in the landing position. The landing position can be controlled on the system side, for example, by changing the size of the liquid droplets or designating the nozzles to discharge the liquid droplets.

In the first example, the nozzle intervals at the end portion of the nozzle plate can be the same between the nozzle array on the upstream side and the nozzle array on the downstream side. In the first example, it is not necessary to change the nozzle interval at the end of the nozzle array between the nozzle arrays, unlike the comparative example, to prevent the landing position of the liquid droplets from deviating. In the first example, as illustrated in FIG. 2A, the nozzle interval at the end of the nozzle array 12a on the upstream side and the nozzle interval at the end of the nozzle array 12b on the downstream side are both x (μm). Thus, the image quality can be enhanced from the viewpoint of the physical nozzle arrangement. As described in the comparative example, if the nozzle intervals at the ends are different between the nozzle array on the upstream side and the nozzle array on the downstream side, it is difficult to enhance the image quality. The nozzle interval at the end refers to the distance between the endmost nozzle of the nozzle array and the nozzle adjacent to the endmost nozzle.

The shape of the nozzle plate 10 can be appropriately selected. The planar shape of the nozzle plate 10 is, for example, a polygon. For example, the nozzle plate having the polygonal shape is easily manufactured to enhance productivity. Examples of the polygonal shape include a trapezoidal shape, a rectangular shape, and a hexagonal shape.

In the first example, the planar shape of the nozzle plate 10 is a trapezoid, and the upper base is on the upstream side and the lower base is on the downstream side. When the planar shape of the nozzle plate 10 is a trapezoid, the number of nozzles that are affected by the conveyance airflow of the recording medium can be reduced on the upstream side of the nozzle plate.

In the first example, the planar shape of the nozzle plate 10 is a trapezoid, and the nozzle arrays are geometrically similar to the planar shape of the nozzle plate. The nozzle plate having such a planar shape and arrangement of the nozzle arrays can be easily manufactured and easily positioned in a head array.

The arrangement of the nozzle arrays geometrically similar to the planar shape of the nozzle plate will be described below. In the first example, for example, as illustrated in FIG. 3, the nozzles at the ends of the nozzle array are arranged along the slant sides (non-parallel sides) of the nozzle plate. Specifically, as illustrated in FIG. 3, the nozzles 11a, 11b, and 11c at the ends of the nozzle arrays are arranged along a slant side 13a of the nozzle plate 10, and the nozzles 11a′, 11b′, and 11c′ at the ends of the nozzle arrays are arranged along a slant side 13b of the nozzle plate 10. In other words, it can be said that the angle of the arrangement direction of the nozzles at the ends of the nozzle arrays with respect to the conveyance direction of the recording medium is the same as the angle of the slant side of the nozzle plate 10. The arrangement of the nozzle arrays geometrically similar to the planar shape of the nozzle plate can be restated as described above.

FIG. 2B is a schematic plan view of a liquid discharge unit of the first example. The liquid discharge unit of the first example includes multiple liquid discharge heads. The liquid discharge unit of the first example has a head array configuration in which the multiple liquid discharge heads are arranged.

As illustrated in FIGS. 2A and 2B, the nozzle plate 10 has a long side and a short side, and two or more liquid discharge heads (mya be referred to simply to as heads) are arranged in a staggered manner in the direction along the long side. In this case, the overlapping region can be formed. As a result, stripe unevenness can be prevented, and thus the image quality can be enhanced.

As illustrated in FIG. 2B, the nozzle arrays are overlapped with each other between the heads in overlapping regions S1, S2, and S3. The nozzle plates having a trapezoidal planar shape are arranged in a staggered manner to form the overlapping regions. The overlapping regions can reduce stripe unevenness between the nozzle plates in the width direction of the recording medium orthogonal to the conveyance direction to enhance the image quality.

### Second Example

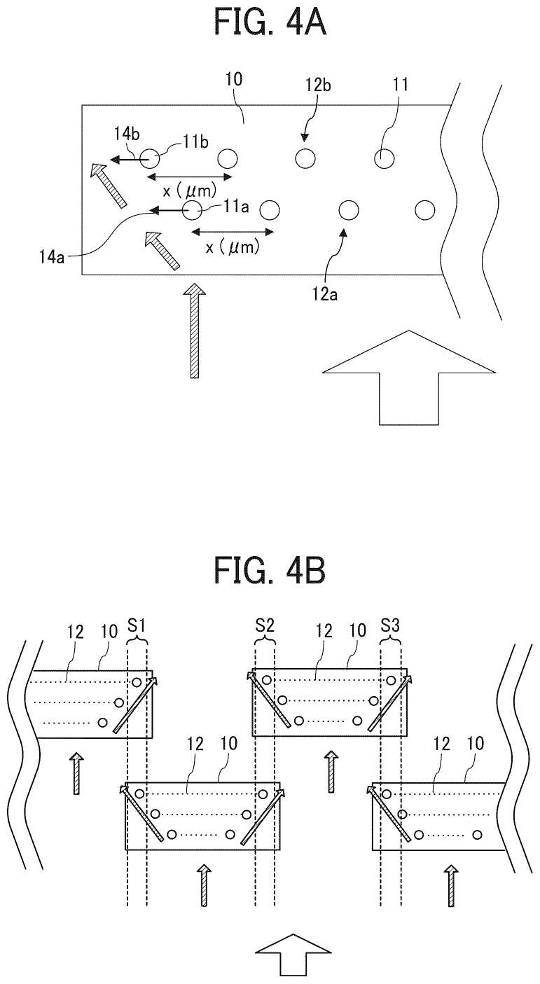

FIGS. 4A and 4B are schematic plan views of a nozzle plate according to a second example. Descriptions of the identical or similar items to those in the first example are omitted. A liquid discharge head of the second example includes a nozzle plate 10 having two or more nozzle arrays 12a and 12b each having nozzles 11 arrayed in the array direction. Although FIG. 4A illustrates the two nozzle arrays 12a and 12b, the number of rows of the nozzle arrays may be three or more.

In the second example, similarly to the first example, the nozzle array distance of the nozzle array on the upstream side is shorter than the nozzle array distance of the nozzle array on the downstream side, for example, as illustrated in FIGS. 4A and 4B. Due to such a configuration, in the second example, the arrow 14a and the arrow 14b schematically illustrating the self-airflows are directed in the same direction. Accordingly, the direction of the change in the landing position due to the conveyance airflow can be the same one direction. As illustrated in FIGS. 4A and 4B, the airflows, which are indicated by the hatched arrows, flowing from the upstream side in the conveyance direction of the recording medium toward the nozzle plate 10 flow along the ends of the nozzle arrays in one nozzle plate 10.

In the second example, the landing position is changed (deviated) in one direction by the conveyance airflow, which facilitates the correction of the change in the landing position. The landing position can be controlled on the system side, for example, by changing the size of the liquid droplets or designating the nozzles to discharge the liquid droplets. In the second example, the nozzle intervals at the end portion of the nozzle plate can be the same between the nozzle array on the upstream side and the nozzle array on the downstream side. As illustrated in FIG. 4A, the nozzle interval at the end of the nozzle array 12a on the upstream side and the nozzle interval at the end of the nozzle array 12b on the downstream side are both x (μm). Thus, the image quality can be enhanced from the viewpoint of the physical nozzle arrangement.

In the second example, the nozzle plate 10 is a rectangular planar shape. The nozzle plate 10 having the rectangular planar shape, which is simpler in the structure of the nozzle plate than a trapezoidal shape, can increase the yield and the number of chips to be obtained in the manufacture of the nozzle plate.

FIG. 4B is a schematic plan view of a liquid discharge unit of the second example. In the liquid discharge unit of the second example, similarly to the first example, the nozzle plate 10 has a long side and a short side, and two or more liquid discharge heads are arranged in a staggered manner in the direction along the long side. Accordingly, the overlapping region (e.g., overlapping regions S1, S2, and S3) can be formed. As a result, stripe unevenness between the nozzle plates can be prevented, and thus the image quality can be enhanced.

### Third Example

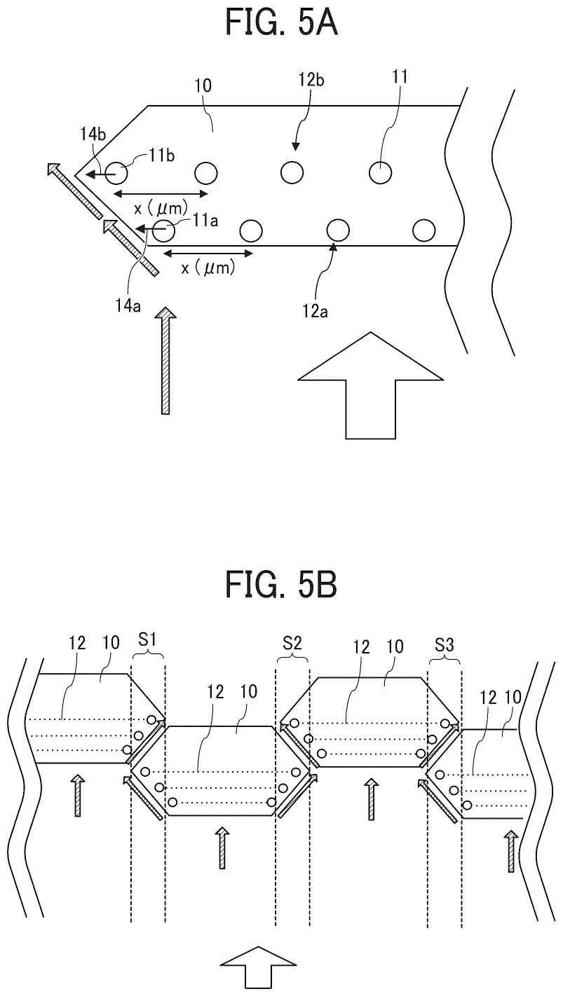

FIGS. 5A and 5B are schematic plan views of a nozzle plate according to a third example. Descriptions of the identical or similar items to those in the above examples are omitted. A liquid discharge head of the third example includes a nozzle plate 10 having two or more nozzle arrays 12a and 12b each having nozzles 11 arrayed in the array direction. Although FIG. 5A illustrates the two nozzle arrays 12a and 12b, the number of rows of the nozzle arrays may be three or more.

In the third example, similarly to the first example, the nozzle array distance of the nozzle array on the upstream side is shorter than the nozzle array distance of the nozzle array on the downstream side, for example, as illustrated in FIGS. 5A and 5B. Due to such a configuration, in the third example, the arrow 14a and the arrow 14b schematically illustrating the self-airflows are directed in the same direction. Accordingly, the direction of the change in the landing position due to the conveyance airflow can be the same one direction. As illustrated in FIGS. 5A and 5B, the airflows, which are indicated by the hatched arrows, flowing from the upstream side in the conveyance direction of the recording medium toward the nozzle plate 10 flow along the ends of the nozzle arrays in one nozzle plate 10.

In the third example, the landing position is changed (deviated) in one direction by the conveyance airflow, which facilitates the correction of the change in the landing position. The landing position can be controlled on the system side, for example, by changing the size of the liquid droplets or designating the nozzles to discharge the liquid droplets. In the third example, the nozzle intervals at the end portion of the nozzle plate can be the same between the nozzle array on the upstream side and the nozzle array on the downstream side. As illustrated in FIG. 5A, the nozzle interval at the end of the nozzle array 12a on the upstream side and the nozzle interval at the end of the nozzle array 12b on the downstream side are both x (μm). Thus, the image quality can be enhanced from the viewpoint of the physical nozzle arrangement.

In the third example, the nozzle plate 10 has a hexagonal planar shape. The nozzle plate 10 having a hexagonal planar shape can narrow the distance between the nozzle plates when multiple heads are mounted on a liquid discharge unit, and the heads can be orderly arranged such that the slant side of the nozzle plate closely faces the slant side of the adjacent nozzle plate. Accordingly, when the multiple heads are arranged in the head array configuration, the accuracy of alignment can be increased, and thus the image quality can be enhanced.

FIG. 5B is a schematic plan view of a liquid discharge unit of the third example. In the liquid discharge unit of the third example, similarly to the first example, the nozzle plate has a long side and a short side, and two or more liquid discharge heads are arranged in a staggered manner in the direction along the long side. Accordingly, the overlapping region (e.g., overlapping regions S1, S2, and S3) can be formed. As a result, stripe unevenness between the nozzle plates can be prevented, and thus the image quality can be enhanced.

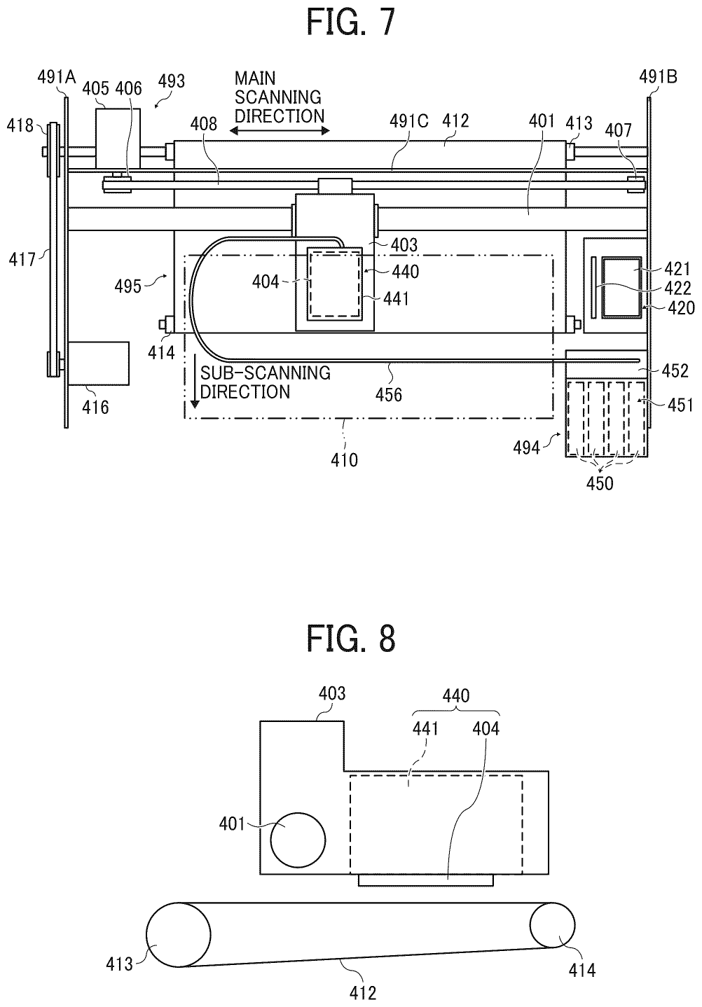

Liquid Discharge Unit and Liquid Discharge Apparatus A liquid discharge apparatus according to an embodiment of the present disclosure is described below with reference to FIGS. 7 and 8. FIG. 7 is a plan view of a part of the liquid discharge apparatus. FIG. 8 is a side view of the part of the liquid discharge apparatus of FIG. 4.

The liquid discharge apparatus is a serial-type apparatus in which a main-scanning moving mechanism 493 reciprocates a carriage 403 in a main scanning direction. The main-scanning moving mechanism 493 includes, for example, a guide 401, a main scanning motor 405, and a timing belt 408. The guide 401 is bridged between left and right side plates 491A and 491B to movably hold the carriage 403. The main scanning motor 405 reciprocates the carriage 403 in the main scanning direction via the timing belt 408 looped around a drive pulley 406 and a driven pulley 407.

The carriage 403 includes a liquid discharge unit 440 in which a liquid discharge head 404 and a head tank 441 are integrated into a single unit. The liquid discharge head 404 of the liquid discharge unit 440 discharges color liquids of, for example, yellow (Y), cyan (C), magenta (M), and black (K). The liquid discharge head 404 is mounted on the liquid discharge unit 440 of the carriage 403 such that a row of the multiple nozzles 11 is arrayed in the sub-scanning direction perpendicular to the main scanning direction. The liquid discharge head 404 discharges the color liquid downward.

A supply mechanism 494 disposed outside the liquid discharge head 404 supplies liquid stored in liquid cartridges 450 to the head tank 441 to supply the liquid to the liquid discharge head 404. The supply mechanism 494 includes a cartridge holder 451 which is a loading device to mount the liquid cartridges 450, a tube 456, and a liquid feed unit 452 including a liquid feed pump. The liquid cartridge 450 is detachably mounted on the cartridge holder 451. The liquid feed unit 452 feeds the liquid from the liquid cartridge 450 to the head tank 441 via the tube 456.

The liquid discharge apparatus further includes a conveyance mechanism 495 to convey a sheet 410 (i.e., a medium). The conveyance mechanism 495 includes a conveyance belt 412 (i.e., a conveyor) and a sub-scanning motor 416 to drive the conveyance belt 412. The conveyance belt 412 attracts the sheet 410 and conveys the sheet 410 to a position facing the liquid discharge head 404. The conveyance belt 412 is an endless belt looped around a conveyance roller 413 and a tension roller 414. The sheet 410 can be attracted to the conveyance belt 412 by, for example, electrostatic attraction or air suction. The conveyance belt 412 circumferentially moves in the sub-scanning direction as the conveyance roller 413 is rotationally driven by the sub-scanning motor 416 via a timing belt 417 and a timing pulley 418.

On one end of the range of movement of the carriage 403 in the main scanning direction, a maintenance mechanism 420 that maintains and recovers the liquid discharge head 404 is disposed lateral to the conveyance belt 412. The maintenance mechanism 420 includes, for example, a cap 421 to cap the nozzle face (i.e., the surface on which the nozzles 11 are formed) of the liquid discharge head 404 and a wiper 422 to wipe the nozzle face.

The main-scanning moving mechanism 493, the supply mechanism 494, the maintenance mechanism 420, and the conveyance mechanism 495 are mounted onto a housing including the side plates 491A and 491B and a back plate 491C.

In the liquid discharge apparatus having the above-described configuration, the sheet 410 is fed and attracted onto the conveyance belt 412 and conveyed in the sub-scanning direction as the conveyance belt 412 circumferentially moves. The liquid discharge head 404 is driven in response to an image signal while the carriage 403 moves in the main scanning direction to discharge liquid onto the sheet 410 not in motion. As a result, an image is formed on the sheet 410.

As described above, the liquid discharge apparatus includes the liquid discharge head according to an embodiment of the present disclosure, thus allowing the stable formation of high-quality images.

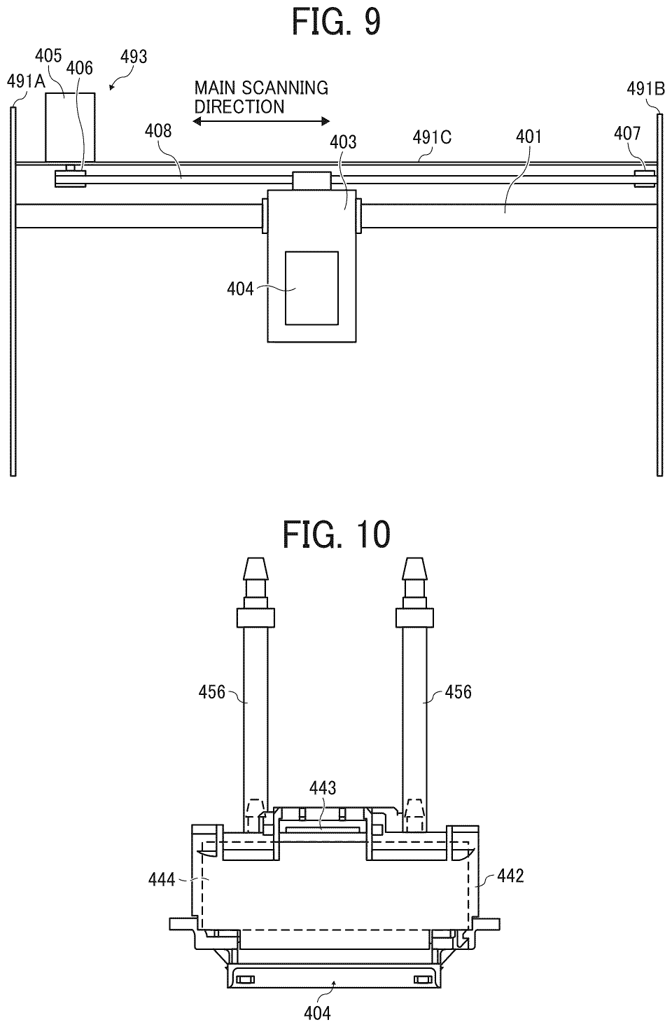

Another liquid discharge unit according to an embodiment of the present disclosure is described below with reference to FIG. 9. FIG. 9 is a plan view of a part of the liquid discharge unit. The liquid discharge unit includes the housing, the main-scanning moving mechanism 493, the carriage 403, and the liquid discharge head 404 among the components of the liquid discharge apparatus described above. The side plates 491A and 491B, and the back plate 491C construct the housing. The liquid discharge unit may further include at least one of the maintenance mechanism 420 or the supply mechanism 494, which may be attached to the side plate 491B.

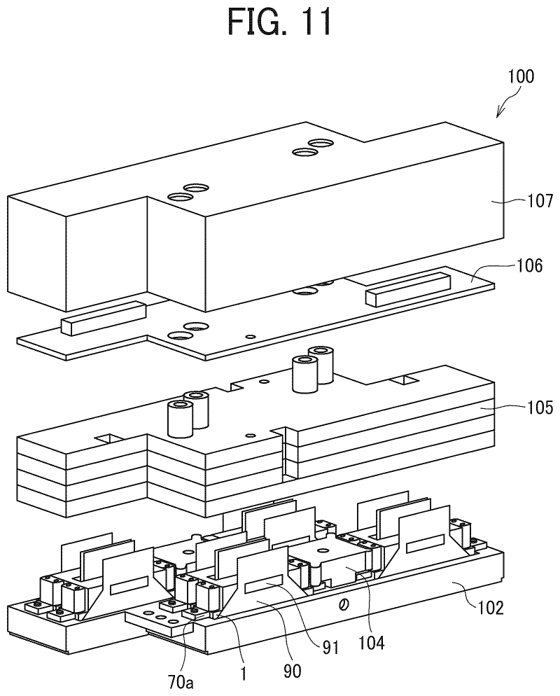

Still another liquid discharge unit according to an embodiment of the present disclosure is described below with reference to FIG. 10. FIG. 10 is a front view of the liquid discharge unit. The liquid discharge unit includes the liquid discharge head 404 to which a channel component 444 is attached, and tubes 456 connected to the channel component 444. The channel component 444 is disposed inside a cover 442. Alternatively, the liquid discharge unit 440 may include the head tank 441 instead of the channel component 444. A connector 443 for electrically connecting to the liquid discharge head 404 is disposed on an upper portion of the channel component 444.

In the above-described embodiments, the “liquid discharge apparatus” includes the liquid discharge head or the liquid discharge unit and drives the liquid discharge head to discharge liquid. The liquid discharge apparatus may be, for example, any apparatus that can discharge liquid to a medium onto which liquid can adhere or any apparatus to discharge liquid toward gas or into a different liquid.

The “liquid discharge apparatus” may further include devices relating to feeding, conveying, and ejecting of the medium onto which liquid can adhere and also include a pretreatment device and an aftertreatment device.

The “liquid discharge apparatus” may be, for example, an image forming apparatus to form an image on a sheet by discharging ink, or a three-dimensional fabrication apparatus to discharge fabrication liquid to a powder layer in which powder material is formed in layers, so as to form a three-dimensional object.

The “liquid discharge apparatus” is not limited to an apparatus that discharges liquid to visualize meaningful images such as letters or figures. For example, the liquid discharge apparatus may be an apparatus that forms patterns having no meaning or an apparatus that fabricates three-dimensional images.

The above-described term “medium onto which liquid can adhere” represents a medium on which liquid is at least temporarily adhered, a medium on which liquid is adhered and fixed, or a medium into which liquid adheres and permeates. Specific examples of the “medium onto which liquid can adhere” include, but are not limited to, a recording medium such as a paper sheet, recording paper, a recording sheet of paper, a film, or cloth, an electronic component such as an electronic substrate or a piezoelectric element, and a medium such as layered powder, an organ model, or a testing cell. The “medium onto which liquid can adhere” includes any medium to which liquid adheres, unless otherwise specified.

Examples of materials of the “medium onto which liquid can adhere” include any materials to which liquid can adhere even temporarily, such as paper, thread, fiber, fabric, leather, metal, plastic, glass, wood, ceramic, construction materials (e.g., wallpaper or floor material), and cloth textile.

Examples of the “liquid” include ink, treatment liquid, deoxyribonucleic acid (DNA) sample, resist, pattern material, binder, fabrication liquid, and solution or liquid dispersion containing amino acid, protein, or calcium.

The liquid discharge apparatus may be an apparatus to move the liquid discharge head and the medium onto which liquid can adhere relative to each other. However, the liquid discharge apparatus is not limited to such an apparatus. For example, the liquid discharge apparatus may be a serial head apparatus that moves the liquid discharge head or a line head apparatus that does not move the liquid discharge head. In consideration of airflows, the line-type is preferable.

Examples of the liquid discharge apparatus further include: a treatment liquid applying apparatus that discharges a treatment liquid onto a sheet to apply the treatment liquid to the surface of the sheet, for reforming the surface of the sheet; and an injection granulation apparatus that injects a composition liquid, in which a raw material is dispersed in a solution, through a nozzle to granulate fine particle of the raw material.

The “liquid discharge unit” refers to a liquid discharge head integrated with functional components or mechanisms, i.e., an assembly of components related to liquid discharge. For example, the “liquid discharge unit” includes a combination of the liquid discharge head with at least one of a head tank, a carriage, a supply mechanism, a maintenance mechanism, or a main-scanning moving mechanism.

The above integration may be achieved by, for example, a combination in which the liquid discharge head and a functional component(s) or mechanism(s) are fixed to each other through, e.g., fastening, bonding, or engaging, and a combination in which one of the liquid discharge head and the functional component(s) or mechanism(s) is movably held to the other. The liquid discharge head and the functional component(s) or mechanism(s) may be detachably attached to each other.

Examples of the liquid discharge unit include the liquid discharge unit 440 in which a liquid discharge head and a head tank are integrated, as illustrated in FIG. 8. Alternatively, the liquid discharge head and the head tank coupled (connected) to each other, for example, via a tube may form the liquid discharge unit as a single unit. A unit including a filter may further be added to a portion between the head tank and the liquid discharge head of the liquid discharge unit.

In another example, the liquid discharge unit may be an integrated unit in which a liquid discharge head is integrated with a carriage.

As yet another example, the liquid discharge unit is a unit in which the liquid discharge head and the main-scanning moving mechanism are combined into a single unit. The liquid discharge head is movably held by a guide that is a part of the main-scanning moving mechanism. Like the liquid discharge unit 440 illustrated in FIG. 9, the liquid discharge head, the carriage, and the main-scanning moving mechanism may form the liquid discharge unit as a single unit.

In another example, the cap that forms a part of the maintenance mechanism is fixed to the carriage mounting the liquid discharge head so that the liquid discharge head, the carriage, and the maintenance mechanism are integrated as a single unit to form the liquid discharge unit.

Further, in still another example, the liquid discharge unit includes tubes connected to the liquid discharge head to which the head tank or the channel component is attached so that the liquid discharge head and the supply mechanism are integrated as a single unit, as illustrated in FIG. 10. The main-scanning moving mechanism may be a guide only. The supply mechanism may be a tube(s) only or a loading device only.

The pressure generator used in the liquid discharge head is not limited to a particular type of pressure generator. The pressure generator is not limited to the piezoelectric actuator (or a laminated-type piezoelectric element) described in the above-described embodiments, and may be, for example, a thermal actuator that employs a thermoelectric transducer element, such as a thermal resistor, or an electrostatic actuator including a diaphragm and opposed electrodes.

In the present specification, the terms “image formation,” “recording,” “printing,” “image printing,” and “fabricating” used herein may be used synonymously with each other.

### Another Liquid Discharge Unit and Another Liquid Discharge Apparatus

Another liquid discharge unit and another liquid discharge apparatus will be described below. The liquid discharge head or the liquid discharge unit of the present embodiment may be a head module. A configuration in which multiple liquid discharge heads of the present embodiment are arranged may be referred to as, for example, a head array configuration

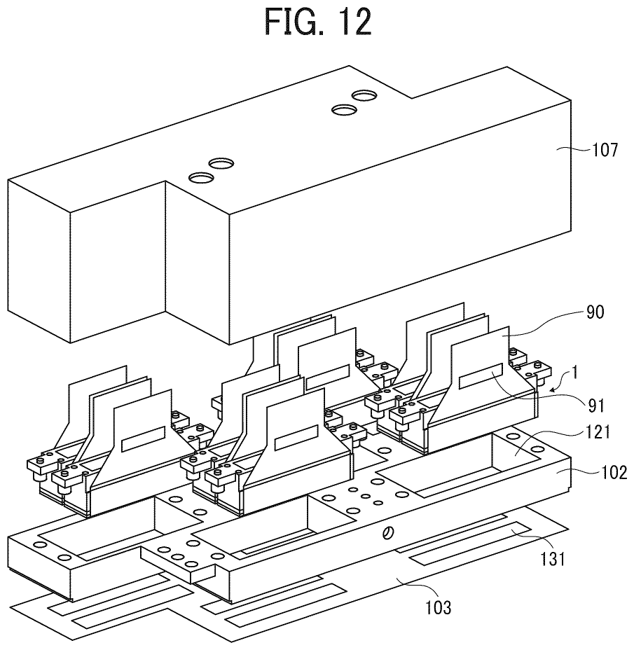

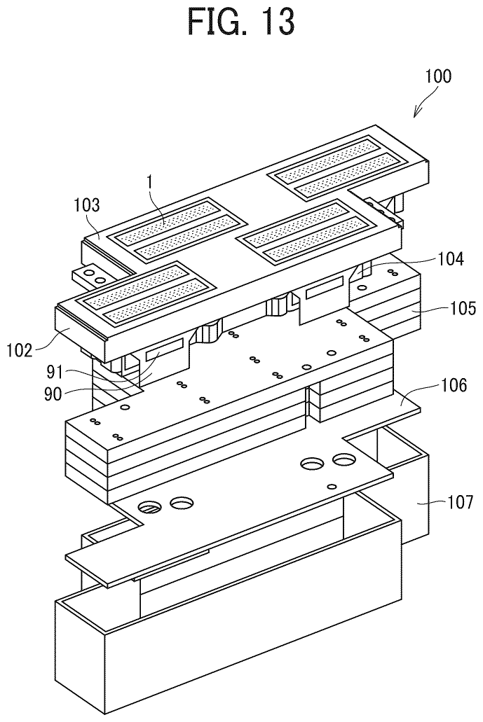

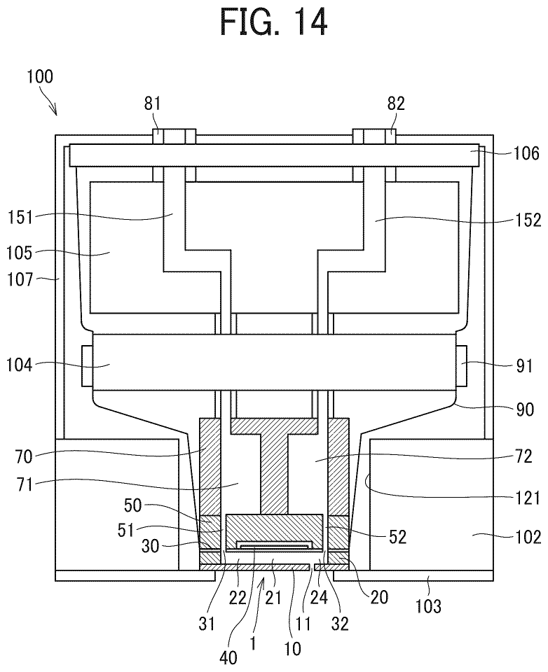

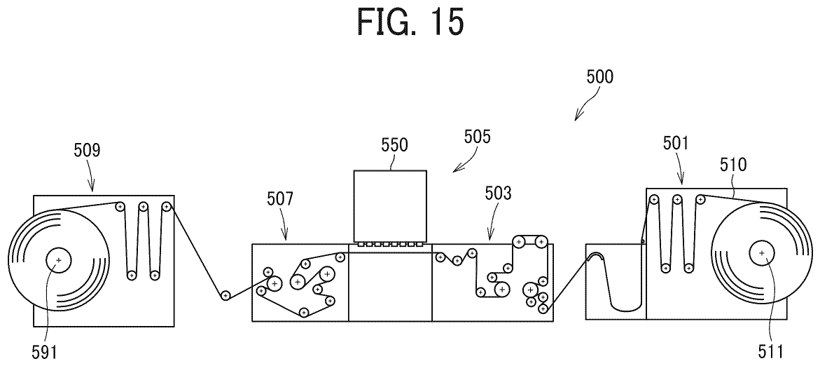

FIG. 11 is an exploded perspective view of a head module according to the present embodiment. FIG. 12 is a further exploded perspective view of the head module of FIG. 11. FIG. 13 is an exploded perspective view of the head module of FIG. 11 as viewed from a nozzle face side. FIG. 14 is a cross-sectional view of one head of the head module of FIG. 11 in a transverse direction of the head.

A head module 100 includes multiple heads 1 to discharge a liquid, a base 102, a cover 103, a heat radiator 104, a manifold 105, a printed circuit board (PCB) 106, and a module case 107.

The head 1 includes the nozzle plate 10, an individual channel plate 20, a diaphragm 30, an intermediate channel plate 50, and a common channel substrate 70. The nozzles 11 are formed in the nozzle plate 10. The individual channel plate 20 defines pressure chambers 21 communicating with the nozzles 11, respectively. The diaphragm 30 includes a piezoelectric element 40. The intermediate channel plate 50 is laminated on the diaphragm 30. The common channel substrate 70 is laminated on the intermediate channel plate 50.

In addition to the pressure chambers 21, the individual channel plate 20 defines individual supply channels 22 communicating with the pressure chambers 21 and individual collection channels 24 communicating with the pressure chambers 21, respectively.

The intermediate channel plate 50 defines intermediate supply channels 51 and intermediate collection channels 52. The intermediate supply channels 51 communicate with the individual supply channels 22 via openings 31 of the diaphragm 30, respectively. The intermediate collection channels 52 communicate with the individual collection channels 24 via openings 32 of the diaphragm 30, respectively.

The common channel substrate 70 defines a common supply channel 71 communicating with the intermediate supply channels 51 and a common collection channel 72 communicating with the intermediate collection channels 52. The common supply channel 71 communicates with a supply port 81 via a channel 151 of the manifold 105. The common collection channel 72 communicates with a collection port 82 via a channel 152 of the manifold 105.

The PCB 106 and the piezoelectric element 40 of the head 1 are connected to each other via a flexible wiring 90, and a driver integrated circuit (IC) 91 is mounted on the flexible wiring 90.

Each of the multiple heads 1 is inserted into an opening 121 of the base 102, and the peripheral edge of the nozzle plate 10 of the head 1 is bonded to the cover 103 bonded and fixed to the base 102 with an adhesive to fix the head 1. The cover 103 has the opening 131 corresponding to the region of the nozzles 11 of the nozzle plate 10, and the cover 103 covers the peripheral edge of the nozzle plate 10 of the head 1. A flange 70a disposed outside the common channel substrate 70 in the longitudinal direction of the head 1 is bonded and fixed to the base 102.

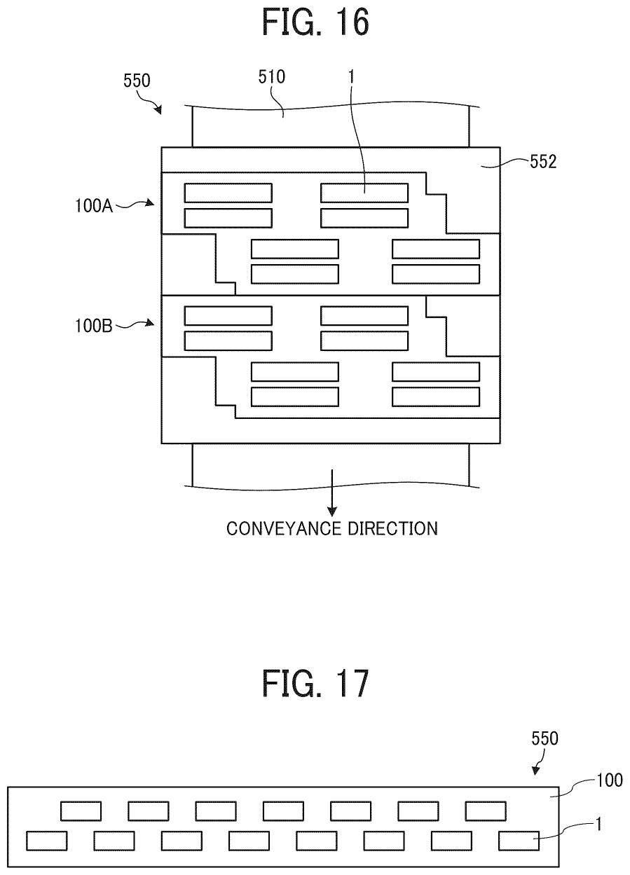

Another liquid discharge apparatus according to the present embodiment will be described below with reference to FIGS. 15 and 16. FIG. 15 is a schematic view of the liquid discharge apparatus. FIG. 16 is a plan view of a head unit of the liquid discharge apparatus.

A printer 500 as a liquid discharge apparatus includes a feeder 501, a guide conveyor 503, a printing device 505, a dryer 507, and a carrier 509. The feeder 501 feeds a continuous medium 510 inward. The guide conveyor 503 as a conveyor guides and conveys the continuous medium 510 such as a continuous sheet of paper or a sheet medium fed inward from the feeder 501. The printing device 505 performs printing by discharging liquid onto the continuous medium 510 to form an image. The dryer 507 dries the continuous medium 510 with the image formed. The carrier 509 feeds the dried continuous medium 510 outward.

The continuous medium 510 (i.e., a medium) is fed from a winding roller 511 of the feeder 501, guided and conveyed with rollers of the feeder 501, the guide conveyor 503, the dryer 507, and the carrier 509, and wound around a take-up roller 591 of the carrier 509. In the printing device 505, the continuous medium 510 is conveyed so as to face a head unit 550. The head unit 550 discharges a liquid onto the continuous medium 510 to form an image. As illustrated in FIG. 16, the head unit 550 includes two head modules 100A and 100B on a common base 552.

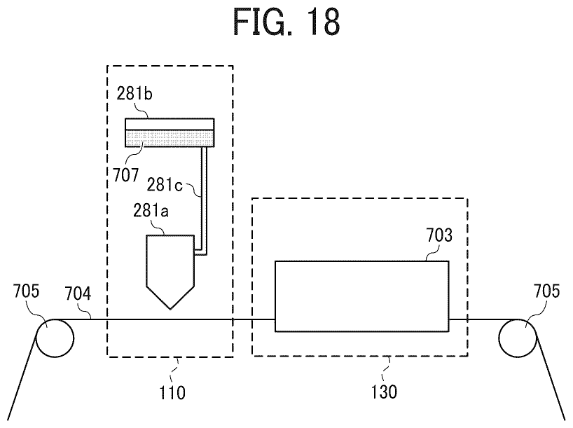

FIG. 17 is a schematic diagram illustrating another head unit 550. As illustrated in FIG. 17, in the head module 100, the arrangement of the liquid discharge head 1 can be appropriately changed. For example, as illustrated in FIG. 17, the liquid discharge heads 1 may be arranged in a staggered manner. As described in the above examples, the planar shape of the nozzle plate of the liquid discharge head is not limited to a rectangle, and may be appropriately selected from, for example, a trapezoid and a hexagon.

### Electrode Manufacturing Apparatus

The liquid discharge apparatus according to an embodiment of the present disclosure may also include an apparatus for manufacturing an electrode and an electrochemical element that is also referred to as an electrode manufacturing apparatus. The electrode manufacturing apparatus is described below.

FIG. 18 is a schematic view of an electrode manufacturing apparatus. The electrode manufacturing apparatus is an apparatus for manufacturing an electrode including a layer containing an electrode material by discharging a liquid composition using a head module including a liquid discharge head.

### Device for Forming Layer Containing Electrode Material and Process of Forming Layer Containing Electrode Material

A discharge device in the electrode manufacturing apparatus illustrated in FIG. 18 is the head module according to the above-described embodiments of the present disclosure. The liquid discharge head of the head module discharges a liquid composition. By so doing, the liquid composition is applied onto an object (i.e., a medium), and a liquid composition layer is formed on the object. The object, which may also be referred to as a discharge target in the following description, is not limited to any particular object and may be appropriately selected depending on the intended purpose, as long as the object is an object on which a layer containing an electrode material is to be formed. Examples of the object include an electrode substrate, i.e., a current collector, an active material layer, and a layer containing a solid electrode material. The object may be an electrode composite layer containing an active material on an electrode substrate, i.e., a current collector.

The discharge device and a discharge process may be a device and a process of forming a layer containing an electrode material by directly discharging a liquid composition as long as the layer containing an electrode material can be formed on a discharge target. The discharge device and the discharge process may be a device and a process of forming a layer containing an electrode material by indirectly discharging a liquid composition.

### Other Devices and Other Processes

Other configurations included in the electrode manufacturing apparatus for manufacturing an electrode composite layer are not limited to any particular configuration and may be appropriately selected depending on the intended purpose, as long as the effects of the present embodiment are not impaired. Other processes included in the method for manufacturing an electrode composite layer are not limited to any particular process and may be appropriately selected depending on the intended purpose, as long as the effects of the present embodiment are not impaired. For example, a heating device and a heating process are examples of the configuration and the process included in the electrode manufacturing apparatus and the manufacturing method of the electrode composite layer.

### Heating Device and Heating Process

The heating device included the electrode manufacturing apparatus for manufacturing an electrode composite layer is a device that heats the liquid composition discharged by the discharge device. The heating process included in the manufacturing method for manufacturing an electrode composite layer is a process of heating the liquid composition discharged in the discharge process. The liquid composition is heated to dry the liquid composition layer.

### Structure to Form Layer Containing Electrode Material by Direct Discharge of Liquid Composition

As an example of the electrode manufacturing apparatus, an electrode manufacturing apparatus that forms an electrode composite layer containing an active material on an electrode substrate, i.e., a current collector, is described below.

As illustrated in FIG. 18, the electrode manufacturing apparatus includes a discharge process device 110 and a heating process device 130. The discharge process device 110 performs a discharge process of applying a liquid composition onto a print base material 704 having a discharge target to form a liquid composition layer. The heating process device 130 performs a heating process of heating the liquid composition layer to obtain an electrode composite layer.

The electrode manufacturing apparatus includes a conveyor 705 that conveys the print base material 704 (i.e., a medium). The conveyor 705 conveys the print base material 704 to the discharge process device 110 and the heating process device 130 in this order at a preset speed. A method of producing the print base material 704 having the discharge target such as an active material layer is not limited to any particular method, and a known method can be appropriately selected.

The discharge process device 110 includes a liquid discharge head 281a that performs an application process of applying the liquid composition onto the print base material 704, a storage container 281b that stores a liquid composition 707, and a supply tube 281c that supplies the liquid composition 707 stored in the storage container 281b to the liquid discharge head 281a. The discharge process device 110 discharges the liquid composition 707 from the liquid discharge head 281a so that the liquid composition 707 is applied onto the print base material 704 to form a liquid composition layer in a thin film shape.

The storage container 281b may be integrated with the electrode manufacturing apparatus that forms the electrode composite layer or may be detachable from the electrode manufacturing apparatus. The storage container 281b may be a container additionally attachable to a container integrated with the electrode manufacturing apparatus for manufacturing the electrode composite layer or to a container detachable from the electrode manufacturing apparatus for manufacturing the electrode composite layer. The storage container 281b that stably stores the liquid composition 707 and the supply tube 281c that stably supplies the liquid composition 707 can be used.

The heating process device 130 performs a solvent removal process of heating and removing the solvent remaining in the liquid composition layer. Specifically, the solvent that remains in the liquid composition layer is heated and dried by a heater 703 of the heating process device 130. Accordingly, the solvent is removed from the liquid composition layer. Thus, the electrode composite layer is formed. The heating process device 130 may perform the solvent removal process under reduced pressure.

The heater 703 is not limited to any particular heater and may be appropriately selected depending on the intended purpose. For example, the heater 703 may be a substrate heater, an infrared (IR) heater, or a hot air heater. The heater 703 may be a combination of at least two of the substrate heater, the IR heater, and the hot air heater. A heating temperature and heating time can be appropriately selected according to the boiling point of the solvent contained in the liquid composition 707 or the thickness of a formed film.

The electrode manufacturing apparatus according to the present embodiment is used to discharge the liquid composition to a desired position on the discharge target. The electrode composite layer can be suitably used, for example, as a part of the configuration of an electrochemical element. The configuration of the electrochemical element other than the electrode composite layer is not limited to any particular configuration, and a known configuration can be appropriately selected. Examples of the configuration other than the electrode composite layer include a positive electrode, a negative electrode, and a separator.

Aspects of the present disclosure are, for example, as follows.

### Aspect 1

A liquid discharge head includes a nozzle plate having two or more nozzle arrays. Nozzles are arrayed in the nozzle array to discharge a liquid onto a recording medium being conveyed. When a distance from a nozzle at one end to a nozzle at the other end in the nozzle array is defined as a nozzle array distance, in the nozzle plate, the nozzle array distance of the nozzle array disposed on the upstream side in the conveyance direction of the recording medium is shorter than the nozzle array distance of the nozzle array disposed on the downstream side in the conveyance direction of the recording medium.

In other words, a liquid discharge head includes a nozzle plate. The nozzle plate has multiple nozzle arrays each having multiple nozzles arrayed in an array direction. The multiple nozzles discharge a liquid onto a recording medium being conveyed in a conveyance direction orthogonal to the array direction. The multiple nozzle arrays include a first nozzle array and a second nozzle array. The first nozzle array has a first distance between both end nozzles of the multiple nozzles at both ends of the first nozzle array in the array direction. The second nozzle array is disposed upstream from the first nozzle array in the conveyance direction. The second nozzle array has a second distance between both end nozzles of the multiple nozzles at both ends of the second nozzle array in the array direction, and the second distance is shorter than the first distance.

### Aspect 2

In the liquid discharge head according to Aspect 1, the planar shape of the nozzle plate is a polygon.

In other words, the nozzle plate has a polygonal planar shape.

### Aspect 3

In the liquid discharge head according to Aspect 1 or 2, the planar shape of the nozzle plate is a trapezoid, and the nozzle arrays are arranged similarly to the planar shape of the nozzle plate.

In other words, the nozzle plate has a trapezoidal planar shape, and the multiple nozzle arrays are geometrically similar to the trapezoidal planar shape.

### Aspect 4

In the liquid discharge head according to Aspect 1 or 2, the planar shape of the nozzle plate is a rectangle.

In other words, the nozzle plate has a rectangular planar shape.

### Aspect 5

In the liquid discharge head according to Aspect 1 or 2, the planar shape of the nozzle plate is a hexagon.

In other words, the nozzle plate has a hexagonal planar shape.

### Aspect 6

A liquid discharge unit includes the liquid discharge head according to any one of Aspects 1 to 5.

In other words, a liquid discharge unit includes the liquid discharge head according to any one of Aspects 1 to 5 and a carriage mounting the liquid discharge head to move the liquid discharge head.

### Aspect 7

A liquid discharge unit includes a plurality of the liquid discharge heads according to any one of Aspects 1 to 5. The nozzle plate has a long side and a short side, and two or more of the liquid discharge heads are arranged in a staggered manner in the long side direction.

In other words, a liquid discharge unit includes multiple liquid discharge heads including the liquid discharge head according to any one of Aspects 1 to 5. The nozzle plate has a long side and a short side, and the multiple liquid discharge heads are arranged in a staggered manner in the array direction.

### Aspect 8

In the liquid discharge unit according to Aspect 7, the multiple liquid discharge heads have a region in which the nozzle arrays partially overlap each other between the nozzle plates of the multiple liquid discharge heads in the conveyance direction of the recording medium.

In other words, each end of the first nozzle array in the array direction of each of the multiple liquid discharge heads is overlapped with each other in the conveyance direction.

### Aspect 9

In the liquid discharge unit according to any one of Aspects 6 to 8, at least one of a head tank to store a liquid to be supplied to the liquid discharge head, a carriage to mount the liquid discharge head, a supply mechanism to supply the liquid to the liquid discharge head, a maintenance mechanism to maintain and recover the liquid discharge head, or a main-scanning moving mechanism to move the liquid discharge head in a main scanning direction is integrated with the liquid discharge head as a single unit.

In other words, a liquid discharge unit includes the liquid discharge head according to any one of Aspects 1 to 5 and at least one of a head tank to store a liquid to be supplied to the liquid discharge head, a carriage to mount the liquid discharge head, a supply mechanism to supply the liquid to the liquid discharge head, a maintenance mechanism to maintain and recover the liquid discharge head, or a main-scanning moving mechanism to move the liquid discharge head in a main scanning direction. The at least one thereof is integrated with the liquid discharge head as a single unit.

### Aspect 10

A liquid discharge apparatus includes the liquid discharge head according to any one of Aspects 1 to 5.

In other words, a liquid discharge apparatus includes the liquid discharge head according any one of Aspects 1 to 5, to discharge the liquid to a recording medium and a conveyor to convey the recording medium to the liquid discharge head.

### Aspect 11

A liquid discharge apparatus includes the liquid discharge unit according to any one of Aspects 6 to 9.

In other words, a liquid discharge apparatus includes the liquid discharge unit according to any one of Aspects 6 to 9, to discharge the liquid to a recording medium and a conveyor to convey the recording medium to the liquid discharge unit.

As described above, according to one aspect of the present disclosure, in the liquid discharge head, it is not necessary to change the nozzle interval between the nozzle arrays at the ends of the nozzle arrays in consideration of the landing position deviation of the liquid droplets due to the conveyance airflow of the recording medium, and the degree of flexibility of the control method for reducing the influence of the landing position deviation of the liquid droplets at the ends of the nozzle arrays is prevented from being narrowed.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A liquid discharge head comprising a nozzle plate having multiple nozzle arrays each having multiple nozzles arrayed in an array direction, the multiple nozzles to discharge a liquid onto a recording medium being conveyed in a conveyance direction orthogonal to the array direction,
wherein the multiple nozzle arrays include:
a first nozzle array having a first distance between both end nozzles of the multiple nozzles at both ends of the first nozzle array in the array direction; and
a second nozzle array upstream from the first nozzle array in the conveyance direction,
the second nozzle array has a second distance between both end nozzles of the multiple nozzles at both ends of the second nozzle array in the array direction, and
the second distance is shorter than the first distance.

2. The liquid discharge head according to claim 1,
wherein the nozzle plate has a polygonal planar shape.

3. The liquid discharge head according to claim 1,
wherein the nozzle plate has a trapezoidal planar shape, and
the multiple nozzle arrays are geometrically similar to the trapezoidal planar shape of the nozzle plate.

4. The liquid discharge head according to claim 1,
wherein the nozzle plate has a rectangular planar shape.

5. The liquid discharge head according to claim 1,
wherein the nozzle plate has a hexagonal planar shape.

6. A liquid discharge unit comprising:
the liquid discharge head according to claim 1; and
a carriage mounting the liquid discharge head to move the liquid discharge head.

7. A liquid discharge unit comprising multiple liquid discharge heads including the liquid discharge head according to claim 1,
wherein the nozzle plate has a long side and a short side, and
the multiple liquid discharge heads are arranged in a staggered manner in the array direction.

8. The liquid discharge unit according to claim 7,
wherein each end of the first nozzle array in the array direction of each of the multiple liquid discharge heads is overlapped with each other in the conveyance direction.

9. A liquid discharge unit comprising:
the liquid discharge head according to claim 1; and
at least one of:
a head tank to store a liquid to be supplied to the liquid discharge head;
a carriage to mount the liquid discharge head;
a supply mechanism to supply the liquid to the liquid discharge head;
a maintenance mechanism to maintain and recover the liquid discharge head; or
a main-scanning moving mechanism to move the liquid discharge head in a main scanning direction,
wherein the at least one thereof is integrated with the liquid discharge head as a single unit.

10. A liquid discharge apparatus comprising:
the liquid discharge head according claim 1, to discharge the liquid to the recording medium; and
a conveyor to convey the recording medium to the liquid discharge head.

11. A liquid discharge apparatus comprising:
the liquid discharge unit according to claim 6, to discharge the liquid to the recording medium; and
a conveyor to convey the recording medium to the liquid discharge unit.
